(19) United States
(12) Patent Application Publication
(10) Pub. No.: US 2013/0318202 A1
(43) Pub. Date: Nov. 28, 2013

(54) Method And Apparatus For Classifying Users

(71) Applicant: TENCENT TECHNOLOGY ( SHENZHEN) COMPANY LIMITED, Shenzhen (CN)

(72) Inventors: Jinfeng MENG, Shenzhen (CN); Liang YU, Shenzhen (CN); Chunlei ZHENG, Shenzhen (CN); Shengyuan WANG, Shenzhen (CN); Lingfei LI, Shenzhen (CN); Xijun DONG, Shenzhen (CN); Boqiang WANG, Shenzhen (CN)

(73) Assignee: TENCENT TECHNOLOGY (SHENZHEN) COMPANY LIMITED, Shenzhen (CN)

(21) Appl. No.: 13/951,602

(22) Filed: Jul. 26, 2013

Related U.S. Application Data
(63) Continuation of application No. PCT/CN2012/070230, filed on Jan. 11, 2012.

(30) Foreign Application Priority Data
Jan. 27, 2011 (CN) 201110032514.1

(51) Int. Cl. H04L 29/08

(52) U.S. Cl. CPC H04L 67/26
USPC 709/217

(57) ABSTRACT

A method and an apparatus for classifying users. The method includes establishing sub-lists in a stored user list of a user according to information of pre-set regions, receiving user location information uploaded by a user terminal of a user, obtaining all user lists that include the user; moving the user in each of the user lists into a sub-list in the user list corresponding to the location of the user; receives a pulling request from a user, obtains information of sub-lists in a user list of the user, sends the information of the sub-lists to the user terminal of the user via a pulling response to enable the user terminal to display users according to the information of the sub-lists received.

### CROSS-REFERENCE TO RELATED APPLICATIONS

This application is a continuation of International Patent Application No. PCT/CN2012/070230, filed on Jan. 11, 2012. This application claims the benefit and priority of Chinese Patent Application No. 201110032514.1, filed Jan. 27, 2011. The entire disclosures of each of the above applications are incorporated herein by reference.

### FIELD

The present disclosure relates to online computer network community technology, and to a method and an apparatus for online computer network community.

### BACKGROUND

This section provides background information related to the present disclosure which is not necessarily prior art.

With developments in computer network technology, software tools such as Instant Messaging (IM) are more commonly implemented using the peer-to-peer (P2P) technique. IM tools have been used by most users in their daily life, work and communications.

Taking QQ as an example (QQ is a IM software produced and issued by Tencent Co., Ltd), a conventional user terminal displays a QQ chat window by using an IM tool. QQ users are classified, i.e. QQ users in a QQ chat window are classified into QQ users in a QQ contact list, QQ users in an address book, QQ users in a list of chat groups and QQ users in a list of QQ users recently chatted with. The QQ contact list is for the user to add contacts into and displaying contacts arranged by contact names or by QQ IDs in a list. The QQ address book records contact information of a QQ user, e.g., phone number, address, e-mail address and so on. The list of QQ chat groups records QQ chat groups the user participated in and QQ users in each QQ chat group. The list of QQ users recently chatted with records QQ users with whom the user chatted recently within a period of time according to configurations pre-set in the IM tool.

When a user logs onto an IM system via an IM tool, a user terminal requests to receive classification information for a chat window of the QQ user from a QQ server and displays the information to the user. For example, information of a QQ contact list is from the QQ server, and all contacts of the QQ user are displayed in a list together with their states. A QQ chat window may subsequently be updated according to configurations in the QQ server or in the user terminal; when the user logs off, the QQ server stores history information of the user.

Because IM tools are used more frequently in daily communications, users require an IM tool to be easy to use and to provide customized services. For example, in contrast to the QQ chat window displayed by a conventional user terminal, a user may prefer that QQ users in the QQ chat window are classified according to a rule customized by the user and more information regarding the QQ users can be displayed. When a user has a large number of QQ contacts displayed in a list one after another, it will be difficult and time-consuming for the user to find a QQ contact.

### SUMMARY

This section provides a general summary of the disclosure, and is not a comprehensive disclosure of its full scope or all of its features.

Various embodiments provide a method for classifying users to reduce the time needed for finding a contact.

Various embodiments also provide an apparatus for classifying users to reduce the time needed for finding a contact.

The method for classifying users may include:

obtaining information of location of each user and information of regions used by a classified user for whom the classification is performed;

obtaining a user list of the classified user, classifying second users in the user list whose locations are corresponding to the same region into a sub-list corresponding to the region by using location information of the second users and the information of the regions to obtain information of sub-lists corresponding to the regions; and

obtaining, by a user terminal, information of sub-lists of the classified user according to a pulling request of the classified user.

An apparatus for classifying users, comprising: a region policy storing module, a region processing module, a user list storing module and a location-information-pulling module; wherein

the region policy storing module is configured to store information of pre-defined regions;

the region processing module is configured to receive information of each user uploaded by a user terminal of the user, search the user list storing module to obtain a user list which includes the user, and send an establishing indication to the user list storing module;

the user list storing module is configured to store a user list of each user, establish a sub-list corresponding to a region corresponding to the information of the location received by the region processing module in response to the establishing indication from the region processing module, and move the user in the user list into the sub-list in the user list; and

the location-information-pulling module is configured to receive a pulling request from a second user, obtain information of sub-lists in a user list of the second user and send the information of the sub-lists to a user terminal of the second user in a pulling response for the user terminal to display the user list according to the information of the sub-lists received.

An apparatus for classifying user, comprising a storing module, a receiving module, a classifying module and a sending module; wherein

the storing module is configured to store a user list of each user and information of a location of a user uploaded by a user terminal;

the receiving module is configured to receive a pulling request from a user terminal;

the classifying module is configured to obtain information of regions, obtain a user list of a user by using information of the user in the pulling request, obtain information of a location of each second user in the user list from the storing module, classify second users in the user list whose locations are corresponding to the same region into a sub-list corresponding to the region to obtain information of sub-lists of the user list corresponding to the regions; and

the sending module is configured to send the information of the sub-lists to the user terminal via a pulling response.

An apparatus for classifying user, comprising a reporting module, a pulling module and a classifying module; wherein

the reporting module is configured to report information of a location of a user to a server;

the pulling module is configured to send a pulling request to the server, obtain information of a location of each second user in a user list of the user from the server by using user information in the pulling request;

the classifying module is configured to obtain information of regions, classify second users in the user list whose locations are corresponding to the same region into a sub-list corresponding to the region to obtain information of sub-lists corresponding to the regions.

The method and apparatus for classifying users establish sub-lists in stored user lists mapped to respective users according to information of pre-set regions; receive user location information uploaded by a user terminal of a user, obtain all user lists which include the user; move the user in each user list into a sub-list in the user list corresponding to the location of the user; receive a pulling request from a user, obtains information of sub-lists in a user list of the user, send the information of the sub-lists to the user terminal of the user via a pulling response to enable the user terminal to display users according to the information of the sub-lists received. As such, by classifying friends in a social network, users are enabled to obtain actual locations of friends of the users, to obtain which friends are located at a location the users are interested in, and to quickly search and find a friend which is located at a specific location.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for classifying users in accordance with various embodiments.

FIG. 2 is a schematic diagram illustrating structure of an apparatus for classifying users in accordance with various embodiments.

Corresponding reference numerals indicate corresponding parts throughout the several views of the drawings.

### DETAILED DESCRIPTION

Example embodiments will now be described more fully with reference to the accompanying drawings.

Embodiments of the present disclosure are hereinafter described in further detail with reference to the accompanying drawings as well as embodiments so as to make the objective, technical solution and merits thereof more apparent.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

In the conventional art, after IM users are classified initially into lists, the classified IM users are displayed one after another in the lists. Each of the lists may include a large number of IM users, which makes it hard for the user to find an IM user he/she wants to contact, e.g. the user may find it difficult to quickly find a contact who is at a specified location.

With developments in mobile communications technology, a user terminal is currently able to provide Location Based Service (LBS), i.e. identifying the location of the user terminal. For example, mobile user terminals, e.g. mobile phones, are generally equipped with the Global Positioning System (GPS) function, and GPS are being supported by more and more user terminals for obtaining location information. Therefore, various embodiments classify IM users in an IM window by using location information of the IM users to enable a user to quickly find an IM user he/she wants to communicate with, especially a contact located at a specific location.

The technical scheme not only can be applied to an IM system, but also can be applied to other applications involving classifying users in a list in a social network system, e.g. a friend list in Facebook or the like.

The method for classifying users may include:

obtaining information of the location (also simply referred to as location information) of each user and information of regions (also simply referred to as region information) used by a classified user for whom the classification is performed;

obtaining a user list of the classified user, classifying second users in the user list whose locations corresponds to the same region into a sub-list corresponding to the region by using location information of the second users and the region information of the classified user to obtain a sub-list of the classified user for each region;

obtaining a sub-list of the classified user for each region in response to a pulling request of the classified user.

The manner of obtaining the location information of each user is not limited. For example, information of the current location of a user may be obtained by using GPS function in a user terminal, or be obtained by using an IP address of a user terminal.

The manner of obtaining information of regions used by the classified user is not limited. For example, information of the regions used by the classified user may be stored in advance or be obtained from the pulling request of the classified user.

The procedure of classifying the second users into a sub-list may be performed by a server or by a user terminal.

In various embodiments, when a server performs the classification, each user reports the location information of the user to the server, then the server classifies the second users in the user list whose locations corresponds to the same region into a sub-list corresponding to the region by using location information of the second users and the region information of the classified user to obtain a sub-list for each region for the classified user.

When a user terminal performs the classification, each user reports the location information of the user to a server, and the user terminal obtains the location information of each user from the server, and then classifies the second users in the user list whose locations correspond to the same region into a sub-list corresponding to the region by using the location information of each user and the region information of the classified user to obtain a sub-list of the classified user for each region.

The procedure of classifying the users may be performed in real time or at regular intervals after the server receives the location information of a user, i.e. sub-lists corresponding to regions are set in advance, or may be performed on demand of the user, i.e., the server classifies users into sub-lists after receiving a pulling request from the classified user.

In various embodiments, when the sub-lists corresponding to the regions are set in advance, the server classifies users into the sub-lists in real time or at regular intervals after receiving the location information of a user. After receiving a pulling request from a user terminal, the server obtains a user list of the user according to information of the user (also simply referred to as user information) in the pulling request, obtains sub-lists corresponding to the regions by using the user list, and sends the sub-lists to the user terminal.

When the sub-lists corresponding to regions are dynamically generated in response to a request from a user, after receiving location information reported by a user, the server updates stored location information of the user. After receiving a pulling request from a user, the server obtains a user list of the user according to user information in the pulling request, classifies users in the user list whose locations correspond to the same region into a sub-list corresponding to the region to generate sub-lists corresponding to the regions, and sends the sub-lists in a pulling response to the user terminal, and the user terminal displays the sub-lists. The region information may be obtained by the server in various manners, e.g., the region information may be set in advance, or may be obtained from the pulling request.

According to various embodiments, when the sub-lists corresponding to regions are dynamically generated in response to a request of a user, after receiving location information reported by a user, the server updates stored location information of the user. After receiving a pulling request from a user, the server obtains a user list of the user according to user information in the pulling request, and sends location information of users in the user list to the user terminal. The user terminal classifies the users in the user list whose locations correspond to the same region into a sub-list corresponding to the region to generate sub-lists corresponding to the regions, and displays the sub-lists. A user terminal may obtain region information in various ways, e.g., the user terminal may set region information in advance, or obtain the region information from the server, or obtain the region information from the pulling request.

The above technical scheme obtains information of the location of each user and information of regions used by the classified user for whom the classification is performed, obtains a user list of the classified user, classifies users in the user list whose locations correspond to the same region into a sub-list corresponding to the region by using the information of the location of each user and the information of the regions used by the classified user to obtain information of sub-lists corresponding to the regions. Thus, the information of the sub-lists clearly shows users located in each region, and thereby the time needed for finding a friend at a specified location is reduced.

The method for classifying users is described in the following with reference to an embodiment which is only for illustrative purposes and not for limiting the protection scope.

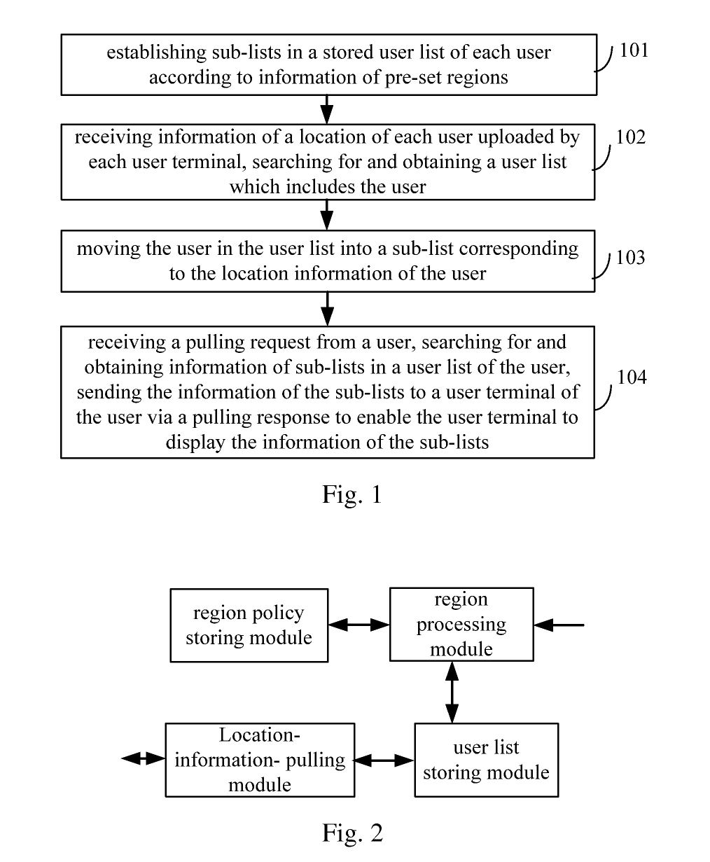

FIG. 1 is a flowchart illustrating a method for classifying users in accordance with various embodiments. As shown in FIG. 1, the method may include the following approach.

In block 101, sub-lists corresponding to pre-set regions are generated in a stored user list corresponding to each user according to information of the pre-set regions.

The regions may be administrative regions, or latitude-longitude areas. An administrative region may be a shopping district, a tourist attraction, a crowded location, a township, a district, a town, a county, a city, a province, or a country. In practice, the regions may also be other administrative areas, e.g., Yunnan-Guizhou-Sichuan area, Hunan-Hubei area, Guangdong-Guangxi area, and so on. Latitude-longitude areas may include regions divided by latitude and longitude, e.g. an area between 115 degrees 13 minutes and 115 degrees 54 minutes west and between 78 degrees 00 minutes and 78 degrees 36 minutes north. The server may store a relation which associates an administrative region with a latitude-longitude area, and send information of the regions to each user terminal.

The pre-set information of regions may be set in the server in advance by an operator, or be set by a user and uploaded to the server, or be set by a third party device and uploaded to the server.

The users may include QQ users, microblog users and all users using a user list in a social network.

Each user is associated with a user list, and this belongs to conventional art. User lists of users may be indexed by using the users. For example, the user list of a QQ user can be indexed by using the QQ ID of the QQ user, i.e. the user list of the QQ user can be obtained by using the QQ ID of the QQ user. User lists may include a list for QQ friends, a list for address book, a list for QQ chat groups, and a list for contacts recently contacted with, and so on. Information of other QQ users having a relation with the QQ user is stored in the lists. In various embodiments, sub-lists corresponding to regions are generated in each user list, e.g., in each of a QQ buddy list, an address list, a QQ chat group list, a recent contacts list and so on. For example, if the regions are administrative provinces, sub-lists respectively corresponding to Yunnan, Guizhou, Sichuan, Hunan, Hubei, and etc. may be generated in each user list. The sub-lists are initiated as a list of null values. The same operations may be performed for other user lists.

In practice, sub-lists of a lower level may be established in each sub-list. For example, sub-lists of a lower level, e.g., a Xujiahui sub-list, a Lujiazui sub-list and so on, may be established in a sub-list corresponding to Shanghai.

In block 102, location information uploaded by a user terminal of a user is received, and user lists which include the user are searched for and identified.

In this block, the server may negotiate beforehand with the user to decide the regions adopted. If the regions adopted are administrative regions, the location information uploaded by the user is information of an administrative region. If the regions adopted are latitude-longitude regions, the location information uploaded by the user may be latitude information and longitude information.

In practice, when uploading location information, the user terminal may disregard the type of regions adopted, and upload location information which is applicable to all types of regions, e.g., information of an absolute location of the user, to the server. Then the server obtains the region of the user by using the location information uploaded by the user and the regions adopted.

In practice, the location information of a user may be obtained through the following approach.

A1, a user turns on GPS in a user terminal to obtain GPS signals.

A2, the user terminal calculates information of the current location by using the GPS signals.

In this approach, the user turns on the GPS in the user terminal and obtains information of the current location of the user. The user terminal calculates information of the current location by using received GPS signals, and this approach can be found in related technical papers and will not be elaborated herein. The user terminal may decide the region to which the current location belongs according to the obtained location information and stored information of regions. In practice, the approach of determining the region to which the current location belongs may be performed by the server.

In practice, the location information of a user may be obtained through the following approach.

B1, the user turns on a positioning function in a user terminal, and obtains identification information of a serving cell in the current network.

In this approach, the user may alternatively obtain information of the IP address of the user terminal.

B2, the user terminal sends a positioning request which includes the identification information of the serving cell to a positioning server.

B3, the positioning server may look up pre-stored relations which associate cell IDs with location information, obtain location information corresponding to the identification information of the serving cell in the positioning request.

B4, the positioning server returns a positioning response which includes the position information to the user terminal.

In practice, the user terminal may use other manners to obtain the location information of the user.

In various embodiments, the server receives location information of the user, searches in stored user lists for the user by using the identification of the user, and obtains user lists which include the user.

In practice, the user may be included in multiple user lists, and the multiple user lists are obtained.

In block 103, the user is moved from the user list into a sub-list corresponding to a region to which the location of the user belongs.

In this approach, if the location information of the user indicates Yunnan and the user is included only in a QQ friend list which is one of user lists of user A, the user is removed from the QQ friend list and put into a sub-list of the QQ friend list corresponding to Yunnan.

In block 104, a pulling request is received from the user, information of sub-lists in a user list of the user is obtained and sent to a user terminal of the user in a pulling response, and the user terminal displays the user list according to the information of the sub-lists received.

In this approach, the user logs onto a software tool and pulls user information associated with the user. The server receives the pulling request, obtains information of sub-lists in a user list of the user by using the user identification in the pulling request, and sends the information of the sub-lists to the user terminal via a pulling response.

The user terminal receives the information of the sub-lists, parses and displays the sub-lists, e.g., displaying QQ users in sub-lists corresponding to Yunnan, Guizhou, Sichuan, Hunan, Hubei, etc. in a QQ friend list. For another example, the QQ users in the sub-list of Shanghai in the QQ friend list may be displayed in districts of Xujiahui, Lujiazui and so on. That is, the user may change the granularity of user selection and adjust the manner of classifying friends or other contacts by selecting the type of regions to be adopted. For example, if the user chooses to classify users according to provinces, friends or other contacts are classified and displayed in different categories corresponding to different provinces; if the user chooses to classify users according to districts, the friends or other contacts are classified and displayed in different categories corresponding to different districts.

In various embodiments, the server may store information of an electronic map and send the information of the electronic map to the user terminal in the pulling response. After receiving the pulling response, when the pulling response includes information of an electronic map, the user terminal identifies each region in the electronic map and displays users in each region on the electronic map when displaying the users. After receiving the pulling response including the information of sub-lists, the user terminal may match information of a region corresponding to a sub-list in the pulling response with information of an electronic map and display users in each region in the electronic map as long as the user terminal is able to obtain an electronic map no matter whether the server has an electronic map or whether the pulling response includes an electronic map, e.g. the user terminal may store information of an electronic map in the user terminal.

In various embodiments, the user terminal may associate information of latitude-longitude regions with an electronic map application. The electronic map application may mark a current location of an IM user on the electronic map according to latitude and longitude data and displays the mark on the electronic map. In another embodiment, after identifying each administrative region in an electronic map, when the regions identified are Huangpu district, Luwan district, Jingan district, Zhabei district and there is one user in each of the regions, and the regions do not include other districts such as Hongkou district, Putuo district, etc., identification information, e.g., the head portrait, the nickname, and the like, of the user is displayed on the electronic map in corresponding areas of Huangpu district, Luwan district, Jingan district and Zhabei district. In yet another embodiment, user information may be displayed according to streets or roads. For example, after the identifying process, there are two users on the Tianjin road, three users on the Nanjing Dong road, identification information including a user head portrait, a nickname and so on of the users are displayed in areas corresponding to the Tianjin road and the Nanjing Dong road.

In various embodiments, the electronic map displayed may be zoomed according to the needs of the user, and the granularity of user selection can be changed by performing zooming. For example, user information is firstly displayed according to provinces in an electronic map, and when the user clicks on Shanghai or a location in Shanghai to zoom-in the electronic map, user information may then be displayed in different districts of Shanghai.

It can be seen that the method for classifying users establishes sub-lists in stored user lists mapped to respective users according to information of pre-set regions; receives user location information uploaded by a user terminal of a user, obtains all user lists which include the user; moves the user in each user list into a sub-list in the user list corresponding to the location of the user; receives a pulling request from a user, obtains information of sub-lists in a user list of the user, sends the information of the sub-lists to the user terminal of the user via a pulling response to enable the user terminal to display users according to the information of the sub-lists received. Therefore, the time needed by a user for finding a friend is reduced and higher efficiency is achieved by a user terminal obtaining and uploading LBS data (location information) and the server analyzing the uploaded location information and classifying users in a social network further into finer categories. The user can obtain knowledge of true location of his/her friends and to view friends in different distances according to his/her selections, e.g., friends in the same district, the same city, the same province, the same country, etc. The user is also able to obtain knowledge of which friends are in an area the user is interested in, friends located closest to the user, or friends in the same city with the user so as to communicate and chat with a friend in the same area with the user. Thus, diversified requirements of users can be satisfied, user experience can be improved, extra values are also added to the IM tool.

FIG. 2 is a schematic diagram illustrating an apparatus for classifying users in accordance with various embodiments. As shown in FIG. 2, the apparatus may include a region policy storing module, a region processing module, a user list storing module and a location-information-pulling module.

The region policy storing module is configured to store information of pre-defined regions.

In various embodiments, information of regions may be set for each user individually, or be set for all users uniformly.

In various embodiments, the region policy storing module is further configured to send the stored information of the regions to each user terminal to enable the user terminal to determine the region the user terminal belongs to according to the information.

The region processing module is configured to receive user location information uploaded by the user terminal of each user, look up the user list storing module to obtain user lists that include the user, and send an establishing indication to the user list storing module. The user location information can be matched with the information of the regions stored in the region policy storing module.

The user list storing module is configured to store user lists of each user, establish a sub-list corresponding to a region matching the user location information received by the region processing module in response to the establishing indication from the region processing module, and move the user in the user list into the sub-list in the user list.

In various embodiments, each user has a user list.

The location-information-pulling module is configured to receive a pulling request from a user, obtain information of sub-lists in a user list of the user and send the information of the sub-lists to a user terminal of the user in a pulling response for the user terminal to display the user list according to the information of the sub-lists received.

In various embodiments, the location-information-pulling module is further configured to set information of an electronic map obtained in advance into the pulling response to enable the user terminal to identify the regions in the electronic map and display users in each of the regions on the electronic map when displaying the users.

In another embodiment, the apparatus for classifying users may include a storing module, a receiving module, a first classifying module and a sending module.

The storing module is configured to store a user list of each user and user location information uploaded by a user terminal.

The receiving module is configured to receive a pulling request from a user terminal.

The first classifying module is configured to obtain region information, obtain a user list of the user and location information of each user in the user list from the storing module by using user information in the pulling request, classify users in the user list whose locations are corresponding to the same region into a sub-list corresponding to the region to obtain information of sub-lists corresponding to the regions of the user list.

The sending module is configured to send the information of the sub-lists to the user terminal via a pulling response.

In another embodiment, the apparatus for classifying users may include a reporting module, a pulling module and a second classifying module. The apparatus may further include a displaying module.

The reporting module is configured to report user location information to a server.

The pulling module is configured to send a pulling request to the server, obtain location information of each user in a user list of the user from the server by using user information in the pulling request.

The second classifying module is configured to obtain region information, classify users in a user list whose location information is corresponding to the same region into a sub-list corresponding to the region to obtain information of sub-lists corresponding to the regions.

The displaying module is configured to display the information of the sub-lists corresponding to the regions of the user.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for classifying users, comprising:
obtaining information of location of each user and information of regions used by a classified user;
obtaining a user list of the classified user by classifying users in the user list whose locations correspond to the same region into a sub-list corresponding to the region by using location information of the users and the information of the regions used by the classified user to obtain a sub-list of the classified user for each region; and
obtaining, by a user terminal, information of a sub-list of the classified user for each region according to a pulling request of the classified user.

2. The method of claim 1, further comprising:
updating, by a server, stored location information of a user after receiving location information reported by the user;
wherein obtaining a user list of the classified user comprises: obtaining, by the server, a user list of a user according to user information in a pulling request after receiving the pulling request from a user;
wherein classifying second users in the user list whose locations correspond to the same region into a sub-list and obtaining by a user terminal information of a sub-list of the classified user for each region comprise: classifying, by the server, users in the user list whose locations correspond to the same region into a sub-list corresponding to the region to generate sub-lists corresponding to regions, and sending information of the sub-lists via a pulling response to the user terminal; or sending, by the server, location information of users in the user list to the user terminal; classifying, by the user terminal, the users in the user list whose locations correspond to the same region into a sub-list corresponding to the region to generate sub-lists corresponding to regions.

3. The method of claim 1, wherein classifying second users in the user list whose locations correspond to the same region into a sub-list and obtaining by a user terminal information of a sub-list of the classified user for each region comprise:
generating, by a server, sub-lists corresponding to pre-set regions in a stored user list corresponding to each user according to information of the pre-set regions;
receiving, by the server, information of a location of a user uploaded by the user, obtaining user lists which include the user, and moving the user from the user list into a sub-list corresponding to a region to which the location information of the user belongs;
receiving, by the server, a pulling request from a user, obtaining information of sub-lists in a user list of the user, and sending the information of the sub-lists to a user terminal of the user via a pulling response to enable the user terminal to display the user list according to the information of the sub-lists received.

4. The method of claim 1, further comprising: after obtaining the information of sub-lists of the user,
displaying, by the user terminal, the information of the sub-lists.

5. The method of claim 4, wherein displaying by the user terminal the information of the sub-lists comprises:
matching, by the user terminal, information of the sub-lists in the pulling response with information of an electronic map obtained by the user terminal, and displaying information of users in each sub-list on the electronic map.

6. The method of claim 4, wherein the pulling response includes information of an electronic map; and wherein displaying by the user terminal the information of the sub-lists comprises:
receiving, by the user terminal, the pulling response, identifying each region in the electronic map and displaying users in each region on the electronic map when displaying the users and when the pulling response includes information of an electronic map.

7. The method of claim 5, further comprising:
zooming the electronic map displayed, and displaying users in each region in the zoomed electronic map.

8. The method of claim 6, further comprising:
zooming the electronic map displayed, and displaying users in each region in the zoomed electronic map.

9. The method of claim 3, wherein the information of the location of the user is matched with the information of the pre-set regions.

10. The method of claim 1, further comprising:
obtaining, by a user terminal, information of a current location of a user by using a Global Position System (GPS); or
obtaining, by a user terminal, identification of a serving cell in the current network by using a positioning function; sending, by the user terminal, a positioning request which includes the identification of the serving cell to a positioning server; searching, by the positioning server, pre-stored relations which associates identifications of cells with information of locations to obtain information of a location corresponding to the identification of the serving cell in the positioning request, and returning a positioning response including the information of the location to the user terminal.

11. The method of any of claims 1, wherein the regions include administrative regions and/or latitude-longitude regions.

12. An apparatus for classifying users, comprising: a region policy storing module, a region processing module, a user list storing module and a location-information-pulling module; wherein
the region policy storing module is configured to store information of pre-defined regions;
the region processing module is configured to receive information of location of each user uploaded by a user terminal of the user, to search the user list storing module to obtain a user list which includes the user, and to send an establishing indication to the user list storing module;
the user list storing module is configured to store a user list of each user, to establish a sub-list corresponding to a region corresponding to the information of the location received by the region processing module in response to the establishing indication from the region processing module, and to move the user in the user list into the sub-list in the user list; and
the location-information-pulling module is configured to receive a pulling request from a second user, to obtain information of sub-lists in a user list of the second user and send the information of the sub-lists to a user terminal of the second user in a pulling response for the user terminal to display the user list according to the information of the sub-lists received.

13. The apparatus of claim 12, wherein the region policy storing module is further configured to send stored information of the regions to each user terminal to enable the user terminal to determine a region to which the location of the user terminal belongs by using the information of the regions and to report information of the region to the region processing module as the information of the location of the user terminal.

14. The apparatus of claim 12, wherein the location-information-pulling module is further configured to set information of an electronic map obtained in advance into the pulling response to enable the user terminal to identify the regions in the electronic map and to display users in each of the regions on the electronic map when displaying the users.

15. The apparatus of claim 13, wherein the location-information-pulling module is further configured to set information of an electronic map obtained in advance into the pulling response to enable the user terminal to identify the regions in the electronic map and to display users in each of the regions on the electronic map when displaying the users.

16. An apparatus for classifying user, comprising a storing module, a receiving module, a classifying module and a sending module; wherein:
the storing module is configured to store a user list of each user and information of locations of users uploaded by user terminals;
the receiving module is configured to receive a pulling request from a user terminal;
the classifying module is configured to obtain information of regions, to obtain a user list of a user by using information of the user in the pulling request, to obtain information of a location of each second user in the user list from the storing module, to classify second users in the user list whose locations are corresponding to the same region into a sub-list corresponding to the region to obtain information of sub-lists of the user list corresponding to the regions; and
the sending module is configured to send the information of the sub-lists to the user terminal via a pulling response.

17. An apparatus for classifying user, comprising a reporting module, a pulling module and a classifying module;
wherein:
the reporting module is configured to report information of a location of a user to a server;
the pulling module is configured to send a pulling request to the server, to obtain information of a location of each second user in a user list of the user from the server by using user information in the pulling request;
the classifying module is configured to obtain information of regions, to classify second users in the user list whose locations are corresponding to the same region into a sub-list corresponding to the region to obtain information of sub-lists corresponding to the regions.

18. The apparatus of claim 17, further comprising a displaying module; wherein
the displaying module is configured to display the information of the sub-lists of the user corresponding to the regions.
